(19) United States
(12) Patent Application Publication
(10) Pub. No.: US 2013/0110582 A1
(43) Pub. Date: May 2, 2013

(54) Method and System for Creating a Database for a Food-Related Social Network and Method of Utilizing the Database

(71) Applicant: Foodsies. com, LLC, Bay Harbor Islands, FL (US)

(72) Inventor: Jason E. Starkman, Bay Harbor Islands, FL (US)

(73) Assignee: FOODSIES.COM, LLC, Bay Harbor Islands, FL (US)

(21) Appl. No.: 13/624,877

(22) Filed: Sep. 21, 2012

Related U.S. Application Data
(63) Continuation-in-part of application No. 13/402,858, filed on Feb. 22, 2012.
(60) Provisional application No. 61/445,326, filed on Feb. 22, 2011.
(60) Provisional application No. 61/537,359, filed on Sep. 21, 2011.

(51) Int. Cl. G06Q 30/02; G06Q 50/00; G06Q 50/12

(52) U.S. Cl. CPC G06Q 30/0201; G06Q 50/01; G06Q 50/12
USPC 705/7.29

(57) ABSTRACT

An online computerized food-related social network includes a database of user preferences regarding food, drinks, cuisines, ingredients, dishes, and restaurants. Users create a profile. Additional food, drinks, cuisines, ingredients, dishes, and restaurants are recommended to the user based on other users' preferences by applying fuzzy logic. The data in the database can be used to provide targeted marketing to the users. The data in the database can be sold to third parties as marketing research.

### CROSS-REFERENCE TO RELATED APPLICATIONS

This application is a continuation-in-part of application Ser. No. 13/402,858 filed Feb. 22, 2012, which claims the benefit of provisional patent Application Nos. 61/445,326 filed Feb. 22, 2011 and 61/537,359 filed Sep. 21, 2011. This application incorporates by reference application Ser. Nos. 13/402,858, 61/445,326, and 61/537,359.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### FIELD OF THE INVENTION

The invention relates to online social media websites related to food and drink.

### BRIEF SUMMARY OF THE INVENTION

FoodDNA is a database that holds descriptions (i.e. analogous to DNA of living things) of users based on the food, drink, and ingredients that they prefer. Users complete a profile questionnaire either online or in other media that is then inputted into a computer database. The questionnaire includes questions like: favorite cuisine, favorite dishes, favorite ingredients, favorite drinks, etc. The information is used to create a profile called the user's FoodDNA. FoodDNA is a term meaning a description of the user based on the food that they eat.

The database of the social network can include or be connected to additional databases for restaurants, markets, food producers, and other food-related business. The additional databases can include food, drinks, recipes, cuisine, ingredients, menu items, and other food-related data. The additional databases can include additional data such as address, hours, pricing, etc.

Information entered by users is compared to other users in the database by using fuzzy logic. Suggestions are made to the user of other foods, drinks, cuisine, and restaurants based on the results. Suggestions can be influenced by comparing data in the additional databases by using fuzzy logic. The user's acceptance and rejection of the suggestions influences subsequent search results.

FoodDNA includes the online computerized database and user interface being utilized in a food-themed social media website.

To create a user's FoodDNA a series of questions are asked of the user. A series of questions (preferably at least five questions) ask the user to identify the user's favorite cuisines. A series of questions (preferably at least five questions) ask the user to identify the user's favorite dishes. A series of questions (preferably at least five questions) ask the user to identify the user's favorite ingredients. Questions ask the user to identify dietary information, for example, is the user diabetic, overweight, etc.

After the information is entered, the system will compare the user profile (i.e. the user's FoodDNA) to other user's data in the database and will suggest food, drink, cuisines, ingredients, dishes, and restaurants based on matches generated using fuzzy logic. The system can include data in additional databases when determining what to suggest to the user.

The invention encompasses a system including a computer acting as a web server and a computerized database connected to the web server for storing users location and preferences for at least one of food, drink, ingredients, recipes, and cuisine.

The invention includes a method of consulting business developers by supplying demographic information and preference for given locations. In this way, a developer can be given demographic information (e.g. the number of people per a given city that like Italian food) and make choices about where to develop a restaurant. The method includes providing information about the number of existing businesses providing food, cuisine, ingredients, and drinks and their ratings for a given locale.

The invention includes a method of targeting advertising based on demographic information stored with the database. For example, advertising for Italian food could be targeted to consumers located in a given locale. The data can be used internally for advertisements on the social network or used to advertisers buying advertising space outside of the social network website.

The invention includes a method for recommending restaurants, foods, drink, and cuisine based on other users in the database of the online social network that share similar preferences.

Although the invention is illustrated and described herein as embodied in a method and system for creating a database for a food-related social network and method of utilizing the database, the invention is not limited to the details shown because various modifications and structural changes may be made without departing from the invention and the equivalents of the claims. However, the construction and method of operation of the invention together with additional objects and advantages thereof will be best understood from the following description of specific embodiments.

### BRIEF DESCRIPTION OF THE SEVERAL VIEWS OF THE DRAWING

Not applicable

### DETAILED DESCRIPTION OF THE INVENTION

A first preferred embodiment of the invention is an online computerized social network for consumers and enthusiasts of food, drink, cooking, and cuisine. The invention allows users to enter their preferences regarding food, drink, ingredients, cuisine, and restaurants. Fuzzy logic is then used to suggest other users, food, drink, cooking, cuisine, and restaurants to the user. Other users, food, drink, cooking, cuisine, and restaurants are added or not added to the user's profile. The added and not-added data are used to update subsequent suggestions to the user.

Demographic data can be sold for purposes beyond the social network to third parties. The data preferably has private information such as name, email, username, and passwords, removed from the data as desired.

Nutritionists can use the data to identify markets and trends. Nutritionists seeking to target a market with particular eating habits can use the database to select locations. Users of the social network can be targeted by nutritionists for advertising.

Preferred embodiments of the invention include methods of using the data in the food-related social network by restaurants. In a first method, a restaurant developer purchases the data from the database. Then, the restaurant developer uses the data to select a location and type of restaurant to develop based on numbers of users preferring the type of cuisine and the number of competing restaurants, and the ratings of the competing restaurants. In another method, restaurants use the data to select menus, dishes, ingredients, and cuisine based on local user's preferences. In another method, restaurants target advertising to the users of the network based on the user's preferences.

Preferred embodiments of the invention include methods of using the data in the food-related social network by food markets. In a first method, a market purchases the data from the database. Then, the market uses the data to stock ingredients, food, drink, and cuisine based on preferences of local users in the social network. In another method, markets target advertising to the users of the network based on the user's preferences. For example, availability and sales prices on preferred items and ingredients can be targeted to specific users based on their preferences.

Preferred embodiments of the invention include methods of using the data in the food-related social network by food markets. In a first method, a market purchases the data from the database. Then, the market uses the data to stock ingredients, food, drink, and cuisine based on preferences of local users in the social network. In another method, markets target advertising to the users of the network based on the user's preferences. For example, availability and sales prices on preferred items and ingredients can be targeted to specific users based on their preferences.

Preferred embodiments of the invention include methods of using the data in the food-related social network by food manufacturers. In a first method, a food manufacturer purchases the data from the database. Then, the food manufacturer uses the data to stock food based on preferences of local users in the social network. In another method, food manufacturers target advertising to the users of the network based on the user's preferences. For example, products and sales prices can be targeted to specific users based on their preferences.

Preferred embodiments of the invention include methods of using the data in the food-related social network for epidemiology. In a first method, the data from the database is provided to the epidemiologist. The data is used to statistically analyze healthcare date based on the data of users in the database.

What is claimed is:

1. An online food-related social network, comprising:
a computerized web server; and
a computerized database connected to said web server, said database including user preferences regarding food, drink, ingredients, cuisine, and restaurants; said computerized database suggesting other users, food, drink, cooking, cuisine, and restaurants to the user based on fuzzy logic.

2. A method of utilizing a database of the food-related social network according to claim 1, which comprises sharing data in said database to a third-party for a purpose other than further building said database.

3. A method of identifying nutritional trends, which comprises providing the database according to claim 1 to a nutritionist.

4. A method of marketing a nutritionist to a user of the food-related social network according to claim 1, which comprises:
identifying dietary habits of the user by analyzing the database; and
displaying an advertisement for the nutritionist to the user.

5. A method for choosing a restaurant to be developed, which comprises:
providing the database of the food-related social network according to claim 1 to a restaurant developer; and
selecting at least one of a location, cuisine, menus, dishes, ingredients items on the database.

6. A method of promoting a restaurant, which comprises targeting advertising for a restaurant based to a user of a food-related social network according to claim 1 based on data stored in said database of the food-related social network.

7. A method of stocking a market, which comprises:
providing data in the database for a food-related social network according to claim 1 to a food market; and
stocking at least one of ingredients, food, drink, and cuisine based on preferences of local users in the social network that are stored in the database.

8. A method of advertising a market, which comprises targeting advertising for at least one of a market, ingredients, food, and drink to the users of the food-related social network according to claim 1 based on the user's preferences.

9. A method of choosing products to be sold to food-related businesses, which comprises:
providing the data from the food-related social network according to claim 1 to a food manufacturer; and
choosing products to stock based on preferences of local users in the social network.

10. A method of advertising food, which comprises:
providing the data from the database of the food-related social network according to claim 1 to a food manufacturer; and
target advertising of the food made by the food manufacturer to the users of the network based on the user's preferences.

11. A preferred embodiments of studying an effect of food on health, which comprises:
providing data from a database of the food-related social according to claim 1 to an epidemiologist; and
statistically analyzing the data with healthcare data.
